(19) United States
(12) Patent Application Publication
(10) Pub. No.: US 2007/0227365 A1
(43) Pub. Date: Oct. 4, 2007

(54) Dual Temperature Pizza Oven

(76) Inventor: Donald Forkner, Madison, WI (US)

Correspondence Address: QUARLES & BRADY LLP, 33 E. MAIN ST, SUITE 900, P.O BOX 2113, MADISON, WI, 53701-2113, US

(21) Appl. No.: 10/580,581

(22) PCT Filed: Nov. 24, 2004
(86) PCT No.: PCT/US04/39581

§ 371 Date: Apr. 11, 2007

Related U.S. Application Data
(60) Provisional application No. 60/524,776, filed on Nov. 25, 2003.

(51) Int. Cl. A47J 37/00

(52) U.S. Cl. 99/332

(57) ABSTRACT

A dual temperature pizza oven (10) is arranged to cook at two different temperatures depending on whether a pre-backed or self-rising crust pizza is to be cooked.

### CROSS-REFERENCE TO RELATED APPLICATIONS

This patent application claims priority from U.S. provisional patent application 60/524,776 filed Nov. 25, 2003.

### BACKGROUND OF THE INVENTION

The present patent application is directed to a pizza oven specifically intended to bake frozen pizzas of two different types. A trend in modern food preparation equipment is toward specialized appliances for specific applications. One type of specialized appliance is the pizza over, a specialized small electric oven optimized for the baking of frozen pizzas, but also used for other types of food articles. A number of designs and types of pizza ovens are currently sold in commerce.

A limitation on the used of pizza ovens arises from the changing technology of frozen pizza. Originally, all frozen pizzas were very similar in terms of their cooking requirements, but the frozen pizzas are commonly sold in today's marketplace are of two different types requiring two different baking procedures. For many years, all frozen pizzas had pre-baked crust which only needed to be heated thoroughly, and the cheese and toppings heated, before being ready for serving. In recent years, a new type of frozen pizza has become popular, a frozen pizza in which the dough is intended to rise during the baking process. To properly bake a pizza with a self-rising crust, the pizza must be baked at a lower temperature for a longer period of time, to give the crust time to heat up and then rise. Many pizza ovens are not capable of properly baking a frozen pizza with a self-rising crust to take full advantage of the product as it was intended.

### BRIEF SUMMARY OF THE INVENTION

The pizza oven as described here is intended to be the simplest possible appliance which still is capable of baking both styles of pizza with the simplest possible interface for the user. In summary, the pizza oven has two simple controls, one intended to initiate a pizza baking operation for a frozen pizza with a pre-baked crust and the other intended to initiate a pizza baking operation for a frozen pizza with a self-rising crust. These two different user control cause the pizza oven to bake the inserted pizzas in very different ways, while maintaining the absolute simplest possible user interface.

### BRIEF DESCRIPTION OF THE SEVERAL VIEWS OF THE DRAWINGS

FIG. 1 is a perspective view of a pizza oven constructed in accordance with the present invention.

FIG. 2 is plan view of the user controls for the pizza oven of FIG. 1.

### DETAILED DESCRIPTION OF THE INVENTION

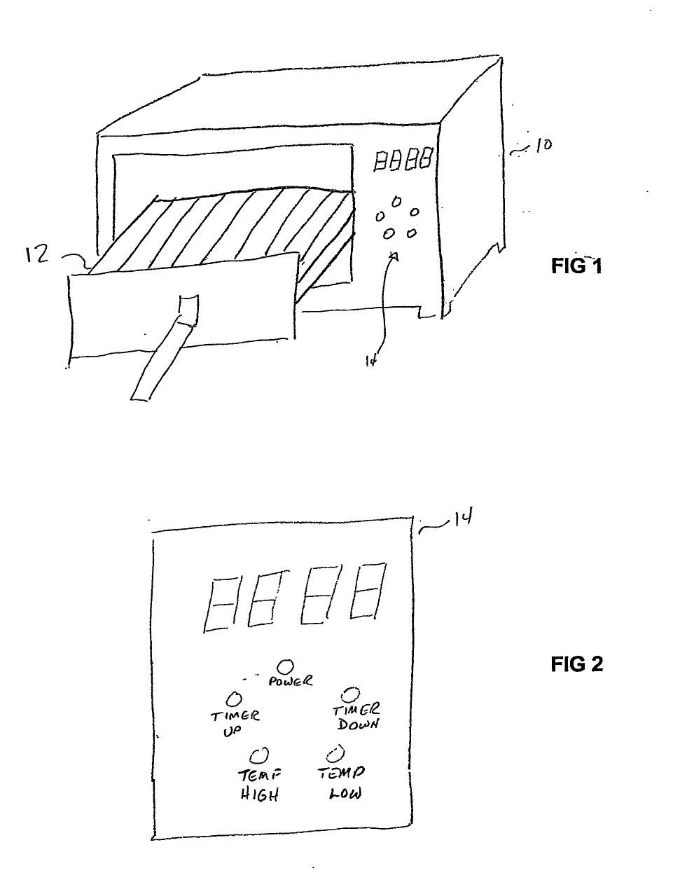

Shown in FIG. 1 is the pizza oven constructed in accordance with the present invention. This pizza oven is designed to have the simplest possible controls for operation while still permitting the optimal baking of the two main types of frozen pizzas.

The oven 10 is a rectangular oven with interior electric heating elements to supply the heating energy. The oven includes a removable tray 12 onto which the item to be baked is placed for insertion into the oven. One difference from the conventional pizza oven is that the oven is provided with a taller front opening, approximately 3 inches. This wider opening is to accommodate the larger size of pizzas with rising crust. User operable controls and a display are located on the front of the oven.

The control display 14 on the front of the oven is shown in greater detail in FIG. 2. The control display include a four digit numeric display to display time of cooking and time left to cook. The control part of the control display has only five user operable inputs, in the form of five buttons. One button is simply a power button, on or off. Two of the buttons are for setting or adjusting the cooking interval, one button being up and one button being down. The other two buttons are alternately for high temperature and low temperature cooking, and these two buttons are linked so that only one setting can be selected at any one time.

In its interior, not shown, the oven includes upper and lower electric heating elements and a temperature sensor. The heating element are under electronic digital control, which also is connected to sense the output of the temperature sensor, to be able to maintain constant temperature, in a manner well known in the art. The front removable tray includes a front panel to seal the front opening in the oven when the tray is inserted if the oven.

In its operation, the oven is controlled so as to default to perform only one of two different processes, depending on which of the two cooking temperature buttons is pressed. If the low temperature button is pressed, the oven will default to cook at around 350° F., and the normal default time period presented to the user will be between twenty and thirty minutes, typically twenty five minutes. The default time period will be presented to the user on the four digit display. If the user presses the power button, cooking of the food begins for the default time period. If the user presses the high temperature cooking option, the oven cooks at around 450° F., and the default time range is set to between twelve to fifteen minutes. The two buttons for controlling the time period of cooking can be used, if needed, to alter the default cooking time period to shorten or lengthen the cooking time period, as experience requires. This option may also be appropriate in the event the oven is used for foods other than pizzas. Note that the cooking temperature is fixed at the choice of the two temperatures appropriate for frozen pizzas.

In way the oven has a pre-set set of conditions for self-rising pizzas and a pre-set set of conditions for pre-baked pizzas all in the same oven with minimal interfaces or effort required by the user. The user has only to pick one of two buttons, one associated with pre-baked crust pizzas, or one associated with self-rising crust pizzas, to operate the oven. While the user has the option to vary cooking time, this is normally not necessary when cooking pizzas, and the unit requires absolutely minimal control by the user.

I/We claim:

1. An oven comprising a housing with an opening in the front and with electric heating elements in the interior thereof;
a removable tray inserted into the opening in the housing and adapted to carry the food to be cooked thereon;
a electronic user operable control integrated into the front of the housing, the control having two temperature selection user selectable controls thereon, one higher temperature selection control causing the oven to cook at a temperature appropriate for pre-baked crust pizzas and one lower temperature selection control causing the oven to cook at a temperature appropriate for self-rising crust pizzas.

2. An oven as claimed in claim 1 wherein the control also included controls for varying time upward and downward, the control defaulting the time for cooking to a time appropriate for either a pre-baked crust pizza or a self-rising crust pizza, depending on which of the temperature controls is selected.

3. An oven as claimed in claim 1 wherein the opening in the front of the oven is at least about 3 inches to accommodate a pizza the crust of which has risen in the oven.

4. A cooking oven comprising
a housing with an opening in the front and with electric heating elements in the interior thereof, the opening in the front of the open being at least about 3 inches;
a removable tray inserted into the opening in the housing and adapted to carry the food to be cooked thereon;
a electronic user operable control integrated into the front of the housing, the control having a time display, two temperature selection buttons, and two timing changing buttons, the control connected such that (1) when a user selects a high temperature button, the control causes the oven to cook at a temperature appropriate for a pre-baked crust pizza and defaults to a cooking time appropriate for a pre-baked crust pizza, (2) when a user selects a low temperature button, the control causes the oven to cook at a temperature appropriate for a self-rising crust pizza and defaults to a cooking time appropriate for a self-rising crust pizza and (3) when the user presses one of the timing changing buttons, the control changing the time of cooking from the default upwards or downwards as selected by the user.
